(19) United States
(12) Patent Application Publication
(10) Pub. No.: US 2024/0346692 A1
(43) Pub. Date: Oct. 17, 2024

(54) OBJECT TRACKING VIA GLASSES DEVICE

(71) Applicant: Motorola Mobility LLC, Chicago, IL (US)

(72) Inventors: Amit Kumar Agrawal, Bangalore (CN); Krishnan Raghavan, Bangalore (IN); Vignesh Karthik Mohan, Bangalore (IN)

(73) Assignee: Motorola Mobility LLC, Chicago, IL (US)

(21) Appl. No.: 18/298,530

(22) Filed: Apr. 11, 2023

(51) Int. Cl. G06T 7/77; G02B 27/01

(52) U.S. Cl. CPC G06T 7/77; G02B 27/017; G02B 2027/0138; G02B 2027/014; G02B 2027/0178

(57) ABSTRACT

Techniques for object tracking via glasses device are described and are implementable to enable different attributes of objects to be tracked via a glasses device. In implementations, user engagement with an object of interest is detected and tracked. Based on the user engagement with the object of interest, engagement data is generated that includes attributes of the user engagement. Further, cost tracking for objects can be implemented based on images of objects captured via a glasses device. Object records can be created for detected objects and can include object attributes such as object identifiers, object costs, object locations, etc.

### BACKGROUND

Today's person is afforded a tremendous selection of devices that are capable of performing a multitude of tasks. For instance, desktop and laptop computers provide computing power and screen space for productivity and entertainment tasks. Further, smartphones and tablets provide computing power and communication capabilities in highly portable form factors. One particularly intriguing device form factor is smart glasses which provide computing functionality in the form of wearable glasses. For instance, virtual reality (VR) glasses and augmented reality (AR) glasses (examples of “glasses devices”) provide an interactive experience in which various types of computer-generated content (“virtual content”) are displayable via a glasses device. Virtual content, for example, includes gaming content, productivity content, entertainment content, communication content, and so forth.

### BRIEF DESCRIPTION OF THE DRAWINGS

Aspects of object tracking via glasses device are described with reference to the following Figures. The same numbers may be used throughout to reference similar features and components that are shown in the Figures. Further, identical numbers followed by different letters reference different instances of features and components described herein.

FIG. 1 illustrates an example environment in which aspects of object tracking via glasses device can be implemented;

FIG. 2 illustrates an example scenario for tracking user interactions with objects of interest in accordance with one or more implementations:

FIG. 3A illustrates an example scenario for tracking costs of objects of interest in accordance with one or more implementations;

FIG. 3B illustrates an example scenario for tracking costs of objects of interest in accordance with one or more implementations;

FIG. 3C illustrates an example scenario for tracking costs of objects of interest in accordance with one or more implementations;

FIG. 3D illustrates a scenario for comparing costs of products in accordance with one or more implementations;

FIG. 4 illustrates an example of a shopping GUI in accordance with one or more implementations;

FIG. 5 illustrates an example alert detail GUI in accordance with one or more implementations;

FIG. 6 illustrates a scenario for performing cost comparison in a physical shopping environment in accordance with one or more implementations;

FIG. 7 illustrates different examples of a cost alert in accordance with one or more implementations;

FIG. 8 illustrates a flow chart depicting an example method for tracking user engagement with an object in accordance with one or more implementations;

FIG. 9 illustrates a flow chart depicting an example method for tracking cost indicators for objects in accordance with one or more implementations;

FIG. 10 illustrates a flow chart depicting an example method for generating cost records for objects in accordance with one or more implementations; and

FIG. 11 illustrates various components of an example device in which aspects of object tracking via glasses device can be implemented in accordance with one or more implementations.

### DETAILED DESCRIPTION

Techniques for object tracking via glasses device are described and are implementable to enable different attributes of objects to be tracked via a glasses device, such as for purposes of tracking object interactions by a user and/or object attributes. A glasses device, for instance, represents a computing device in a glasses form factor, such as augmented reality (AR) glasses, virtual reality (VR) glasses, smart glasses, and so forth.

In implementations, user engagement with an object of interest is detected and tracked. The object of interest, for instance, represents content such as digital content, AR/VR content, physical content, etc. Alternatively or additionally the object can represent a physical object and/or a combination of digital content and physical objects. Based on the user engagement with the object of interest, engagement data is generated that includes attributes of the user engagement, such as an image of the object of interest, a duration of time of the user engagement, a level of user engagement, etc. The engagement data can be stored and utilized for different purposes, such as subsequent retrieval by the user to obtain information and/or view content pertaining to the engagement with the object of interest.

Further to implementations, cost tracking for objects can be implemented based on images of objects captured via a glasses device. For instance, when a user wearing a glasses device visits a physical location that has products for sale (e.g., a market, a mall, etc.), the glasses device can gather image data and perform object recognition to recognize different products available for purchase. Further, the glasses device can capture cost data indicting costs for respective products. Thus, object records for different products can be generated that include data such as product ID, product cost, product location, etc. The object records can then be used such as to perform price comparisons, such as to products available in online platforms, products available at other physical sources, etc. For instance, based on the price comparisons, a user can be alerted when lower cost items are available.

Accordingly, the described techniques are automated and are able to gather object information such as user engagement with objects and product costs without requiring user input. Thus, the described techniques provide for increased efficiency and decreased user effort.

While features and concepts of object tracking via glasses device can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

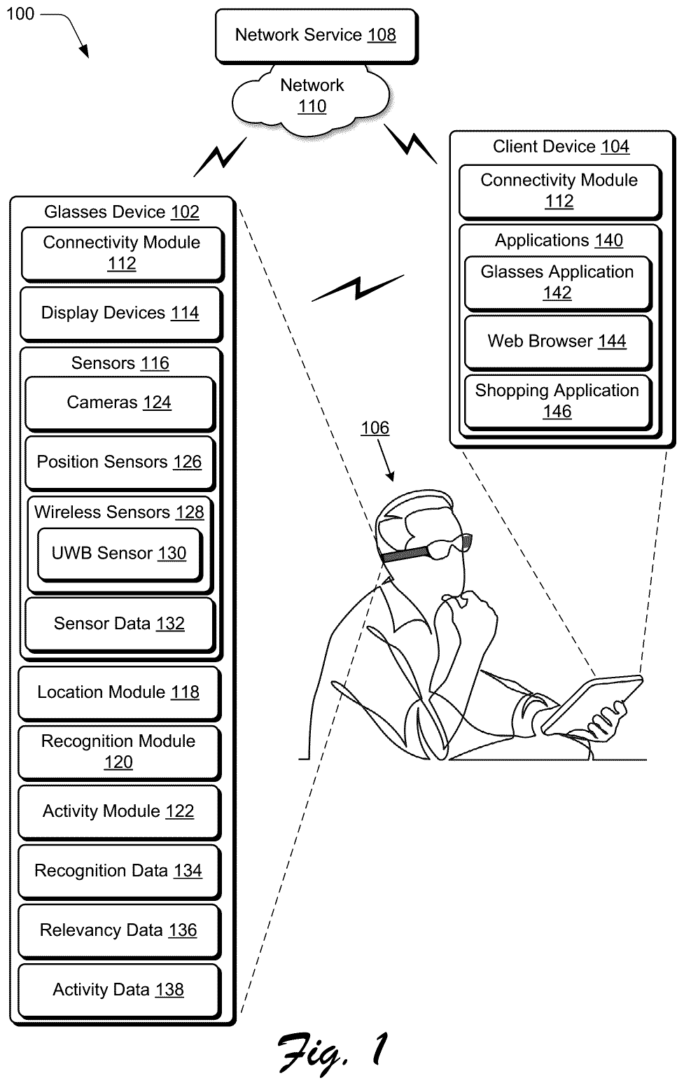

FIG. 1 illustrates an example environment 100 in which aspects of object tracking via glasses device can be implemented. The environment 100 includes a glasses device 102, a client device 104 associated with a user 106, and a network service 108 connected to a network 110. In at least one implementation the glasses device 102 and the client device 104 are interconnectable such as via wireless and/or wired connectivity. For instance, the glasses device 102 and the client device 104 can interconnect via direct inter-device wireless and/or wired connectivity, and/or via connectivity to the network 110. The glasses device 102 represents an instance of a smart glasses device such as augmented reality (AR) glasses, virtual reality (VR) glasses, and so forth. Further, the client device 104 can be implemented in various ways and according to various form factors such as a smartphone, tablet device, a laptop computer, a wearable computing device, and so forth. The network 110 can be implemented in various ways and according to a variety of different architectures, including wireless networks, wired networks, and combinations thereof.

The glasses device 102 includes various functionalities and data that enable the glasses device 102 to perform different aspects of object tracking via glasses device discussed herein, including a connectivity module 112, display devices 114, sensors 116, a location module 118, a recognition module 120, and an activity module 122. The connectivity module 112 represents functionality (e.g., logic and hardware) for enabling the glasses device 102 to interconnect with other devices and/or networks, such as the client device 104 and the network 110. The connectivity module 112, for instance, enables wireless and/or wired connectivity of the glasses device 102. In a wireless scenario the connectivity module 112 enables connectivity and data communication via a variety of different wireless protocols, such as wireless broadband, wireless cellular, Wireless Local Area Network (WLAN) (e.g., Wi-Fi), Wi-Fi Direct, wireless short distance communication (e.g., Bluetooth™ (including Bluetooth™ Low Energy (BLE)), Near Field Communication (NFC)), and so forth.

The display devices 114 represent functionality for visual output of content by the glasses device 102. In an example implementation the display devices 114 include a display surface and/or set of display surfaces and a projection device for projecting visual content onto the display surface(s) such that the visual content is viewable by a user wearing the glasses device 102.

The sensors 116 represent functionality for detecting various physical and/or logic conditions pertaining to the glasses device 102. In this particular example the sensors 116 include cameras 124, position sensors 126, and wireless sensors 128. The cameras 124 represent functionality for detecting visual objects in an environment surrounding the glasses device 102 and can generate visual data that describes the visual objects. The position sensors 126 represent functionality for determining a position and orientation of the glasses device 102 and for detecting changes in position and orientation of the glasses device. Examples of the position sensors 126 include an accelerometer, a gyroscope, a magnetometer, a GPS and/or other geographic system sensor, and so forth.

The position sensors 126 can be implemented to detect a position of the glasses device, such as a geographic position, a physical location, a relative position within a physical location, and so forth. Further, the position sensors 126 can enable a spatial orientation of the glasses device 102 to be detected and can be implemented in various ways to provide different types of orientation detection, such as 3 degrees of freedom (3-DOF), 6 degrees of freedom (6-DOF), 9 degrees of freedom (9-DOF), and so forth. The wireless sensors 116 represent functionality to detect direct types of wireless signal, such as wireless signal transmitted in different frequencies. The wireless sensors 116, for instance, include an antenna and/or set of antennas tuned to detect wireless signal received via different wireless frequencies. The wireless sensors 116 include an ultra-wideband (UWB) sensor 130 which is operable to receive and detect wireless signal in UWB frequencies.

These examples of sensors 116 are not to be construed as limiting and sensors 116 are implementable to include a variety of different sensor types and sensor instances for sensing physical and logic phenomena.

The location module 118 represents functionality for determining a location of the glasses device 102. The location module 118, for instance, can receive sensor data 132 from the sensors 116 to determine a location of the glasses device 102, such as a physical location including a geographic location, a street address, a known location, a physical facility, and so forth. The location module 118 can utilize various types of sensor data 132 for determining a location of the glasses device 102, such as image data generated by the cameras 124, position data generated by the position sensors 126, wireless data generated by the wireless sensors 116, and so forth. In implementations the location module 118 can track locations where the glasses device 102 is detected such as to determine locations frequently visited by the user 106.

The recognition module 120 represents functionality to perform various types of visual recognition of visual objects detected in vicinity of the glasses device 102. The recognition module 120, for instance, can receive sensor data 132 from the cameras 124 and perform various types of image recognition on the sensor data 132, such as recognize physical objects, perform text capture and text recognition, and so forth. The recognition module 120 can generate recognition data 134 that includes data describing various detected visual objects, such as identifiers and attributes of recognized visual objects. For instance, as the user 106 moves between different locations, the recognition module 120 can recognize objects and populate data to the recognition data 134 describing the recognized objects. Further, the recognition module 120 can obtain position data from the location module 118 and tag recognized objects with a position at which the recognized objects were detected. Thus, visual objects in the recognition data 134 can be tagged with various information, such as object identity, object attributes (e.g., visual attributes), object location, time and data that the visual objects are detected, etc.

In implementations the recognition module 120 can utilize relevancy data 136 in conjunction with performing object recognition and storing the recognition data 134. The relevancy data 136, for instance, describes objects of interest to the user 106. The relevancy data 136 can be generated in various ways, such as via user interaction to expressly define the relevancy data 136, implicitly via observed user behaviors, by obtaining user preferences and/or other data describing objects of interest the user 106 (e.g., shopping lists, favorites lists, wish lists, etc.), and so on. Thus, in implementations the recognition module 120 can process received image data and store recognition data 134 for recognized objects that are indicated by the relevancy data 136 as being relevant, while filtering out (e.g., not storing) visual data for recognized objects that are not indicated by the relevancy data 136 as being relevant.

The activity module 122 represents functionality for detecting and tracking various activities associated with the glasses device 102, such as activities of the user 106. The activity module 122, for instance, can utilize sensor data 132 from the position sensors 126 to track different locations where the glasses device 102 is present. Further, the activity module 122 can track behaviors of the user 106, such as durations of time that the user 106 is present at different locations, objects with which the user 106 interacts, content with which the user 106 engages, and so forth. Based on the observed activities associated with the glasses device 102 and the user 106, the activity module 122 can generate activity data 138 that describes the various activities.

The client device 104 includes functionality that enables the client device 104 to participate in various aspects of object tracking via glasses device described herein including a connectivity module 112 and applications 140. The connectivity module 112 represents functionality (e.g., logic and hardware) for enabling the client device 104 to interconnect with other devices and/or networks, such as the glasses device 102. The connectivity module 112, for instance, enables wireless and/or wired connectivity of the client device 104. For instance, the connectivity module 112 enables direct connectivity (e.g., wireless and/or wired) with between the client device 104 and the glasses device 102. Further, the connectivity module 112 can enable connectivity to the network 110, such as via wireless and/or wired connectivity.

The applications 140 represent functionality for performing various tasks via the client device 104, such as productivity tasks, gaming, web browsing, social media, and so forth. The applications 140 includes a glasses application 142, a web browser 144, and a shopping application 146. The glasses application 142 represents functionality for interaction between the client device 104 and the glasses device 102. For instance, the glasses application 142 can interact with the glasses device 102 to configure the glasses device 102 and to obtain data from the glasses device 102, such as the recognition data 134, the relevancy data 136, and the activity data 138.

The web browser 144 represents functionality for browsing different network locations, such as the internet. The shopping application 146 represents functionality for performing online shopping.

Further to the environment 100, the network service 108 represents functionality for performing various aspects of object tracking via glasses device described herein in a network context. For instance, functionality of the glasses device 102 can be configured and/or controlled at least in part via the network service 108. Further, data generated by the glasses device 102 can be communicated to the network service 108, such as for storage at the network service 108 and/or transmission to the client device 104.

Having discussed an example environment in which the disclosed techniques can be performed, consider now some example scenarios and implementation details for implementing the disclosed techniques.

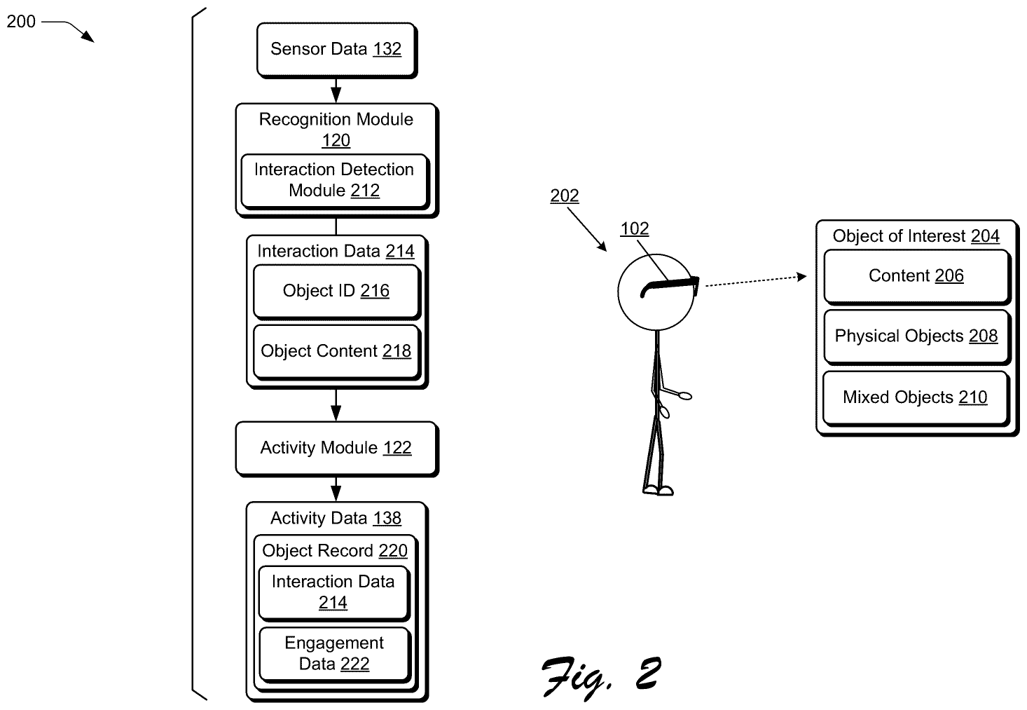

FIG. 2 depicts an example scenario 200 for tracking user interactions with objects of interest in accordance with one or more implementations. The scenario 200 can be implemented in the environment 100 and incorporates attributes of the environment 100 introduced above.

In the scenario 200, a user 202 is wearing the glasses device 102 and viewing and/or interacting with an object of interest 204. The object of interest 204 can represent various entities with which the user 202 can interact, such as content 206, physical objects 208, and mixed objects 210. The content 206, for instance, can represent digital content such as web content and/or other digital media displayed by the web browser 144. The content 206 may also include virtual content such as digital content presented in an AR/VR environment, such as displayed on the display devices 114 of the glasses device 102. Alternatively or additionally the content 206 can represent other types of content such as text and/or images on a physical medium such as a book, a magazine, a newspaper, etc. These examples are presented for purposes of example only and the content 206 can take a variety of different forms.

The physical objects 208 represent different real-world objects that the user 202 can view and interact with. Examples of the physical objects 208 include inanimate objects (e.g., a computer, a tool, an object of commerce such as a retail item encountered while shopping, a workpiece, etc.) and animate objects such as persons and animals. The mixed objects 210 represent mixed object types, such as a combination of content 206 and physical objects 208. The mixed objects 210, for instance, can include a combination of digital content 206 and physical objects 208 that the user 202 views and/or interacts with via the glasses device 102, such as in an AR environment.

Further to the scenario 200, while the user 202 interacts with the object of interest 204, the recognition module 120 receives sensor data 132 from the sensors 116. The sensor data 132, for instance, includes image data captured by the cameras 124 and position data captured by the position sensors 126. Further, the recognition module 120 implements an interaction detection module 212 to process the sensor data 132 and detect that the user 202 is interacting with the object of interest 204. The interaction detection module 212 can detect the user interaction with the object of interest 204 in various ways and using the sensor data 132, such as via image recognition of the object of interest 204, gaze detection that detects that the user's gaze is directed toward the object of interest, orientation detection that detects that the object of interest 204 is within a field of view the glasses device 102, and so forth.

Accordingly, based on detecting the user interaction with the object of interest 204, the recognition module 120 generates interaction data 214 that describes aspects of the user interaction with the object of interest 204. The interaction data 214, for instance, includes an object identifier (ID) 216 that identifies the object of interest 204. The recognition module 120, for instance, utilizes object recognition to recognize an object type and/or object instance of the object of interest 204. The recognition module 120 can then tag the interaction data 214 with the object ID 216 identifying the object type and/or instance of the object of interest 204.

The interaction data 214 also includes object content 218 that is captured and/or generated for the object of interest 204. The object content 218, for instance, includes an image of the object of interest 204, such as a still image and/or video content captured of the object of interest 204 via the cameras 124. The object content 218 may also include other types of content, such as audio content captured via the sensors 116.

Further to the scenario 200, the recognition module 120 communicates the interaction data 214 to the activity module 122 and the activity module 122 generates an object record 220 as part of the activity data 138 and based at least in part on the interaction data 214. The object record 220, for instance, includes the interaction data 214 and engagement data 222. The engagement data 222 can describe various attributes of interaction by the user 202 with the object of interest 204, such as a date, day, and time of the user interaction, a duration of time of the user interaction, a level of engagement of the user 202 with the object of interest 204 (e.g., whether the user was actively or passively engaged), and so forth.

In implementations, the activity module 122 can utilize an engagement time threshold for managing the object record 220. The engagement time threshold can be defined as a duration of time and in various ways, such as in seconds, minutes, and so forth. For instance, if a duration of user engagement with the object of interest 204 (e.g., as detected by the recognition module 120) exceeds the engagement time threshold, the activity module 122 can store the object record 220 for subsequent retrieval. However, if the duration of user engagement with the object of interest 204 is less than the engagement time threshold, the activity module 122 may discard the object record 220. This can prevent excessive burden on data storage resources such as to store object records 220 that may be of less interest to the user 202.

Accordingly, in implementations where the object record 220 is stored for later retrieval, the user 202 may at a subsequent time access the object record 220 to obtain the interaction data 214, such as to obtain the object content 218. For instance, where the object content 218 includes an image of the object of interest 204, the user 202 can retrieve and view the image.

In implementations the scenario 200 can be implemented independent of user interaction to expressly generate the interaction data 214 and the object record 220. For instance, the interaction data 214 is generated by the recognition module 120 and based on receiving the sensor data 132 generated by the sensors 116. Further, the recognition module 120 and the activity module 122 can interact to enable the object record 220 to be generated without direct interaction by the user 202. Thus, the system can enable user interactions with objects of interest to be monitored and recorded based on observed user behavioral triggers.

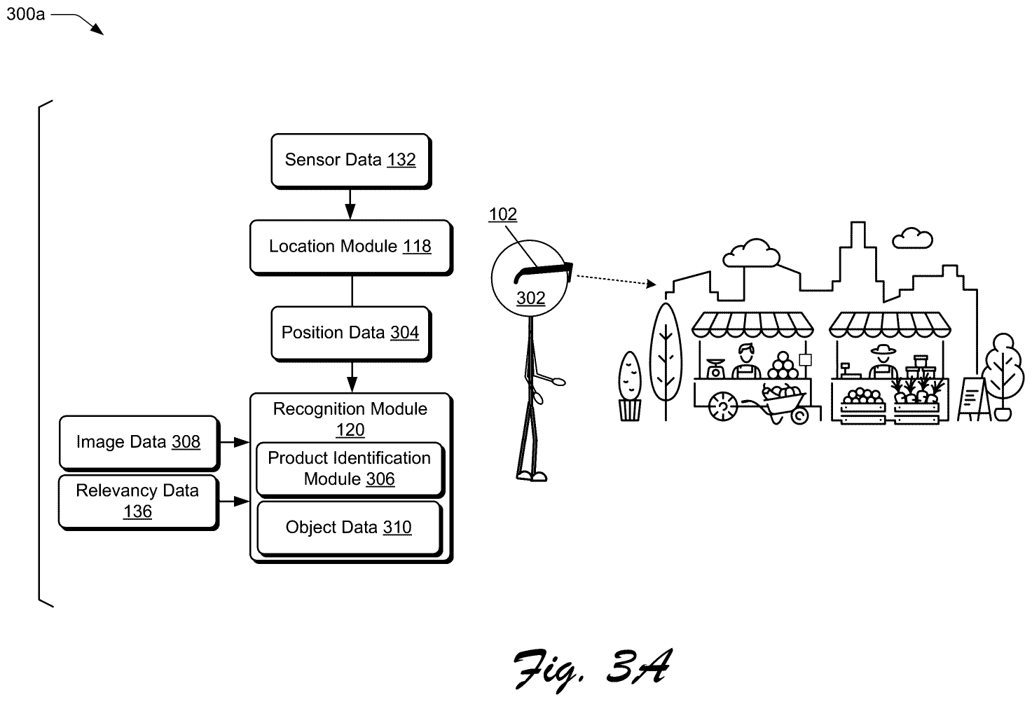

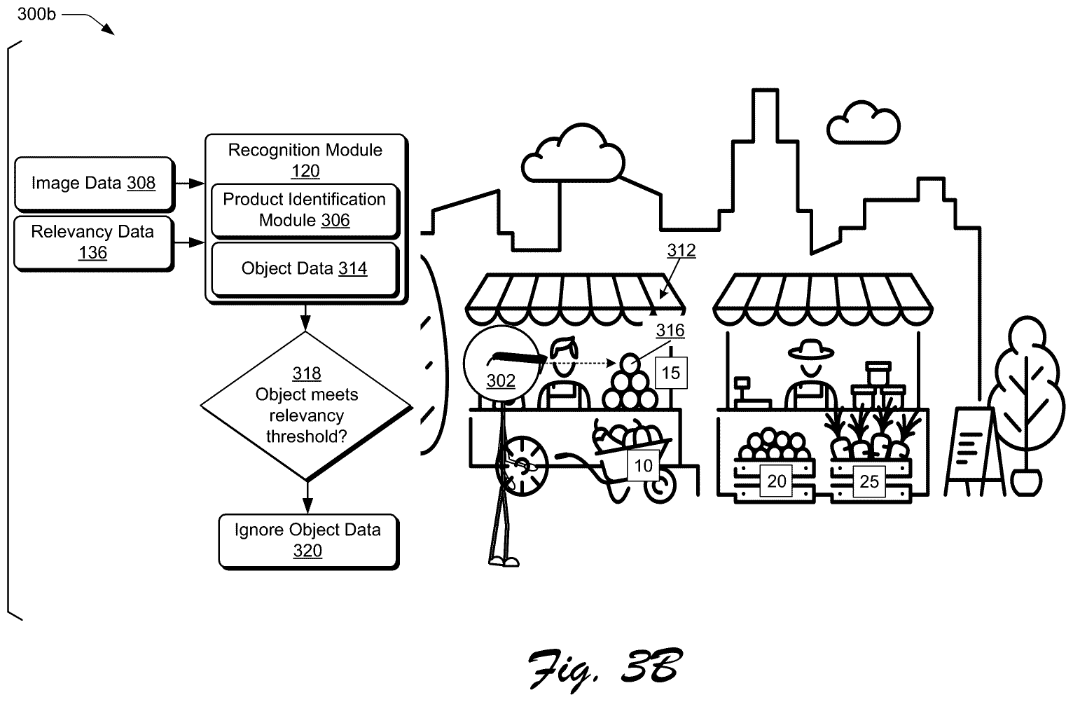

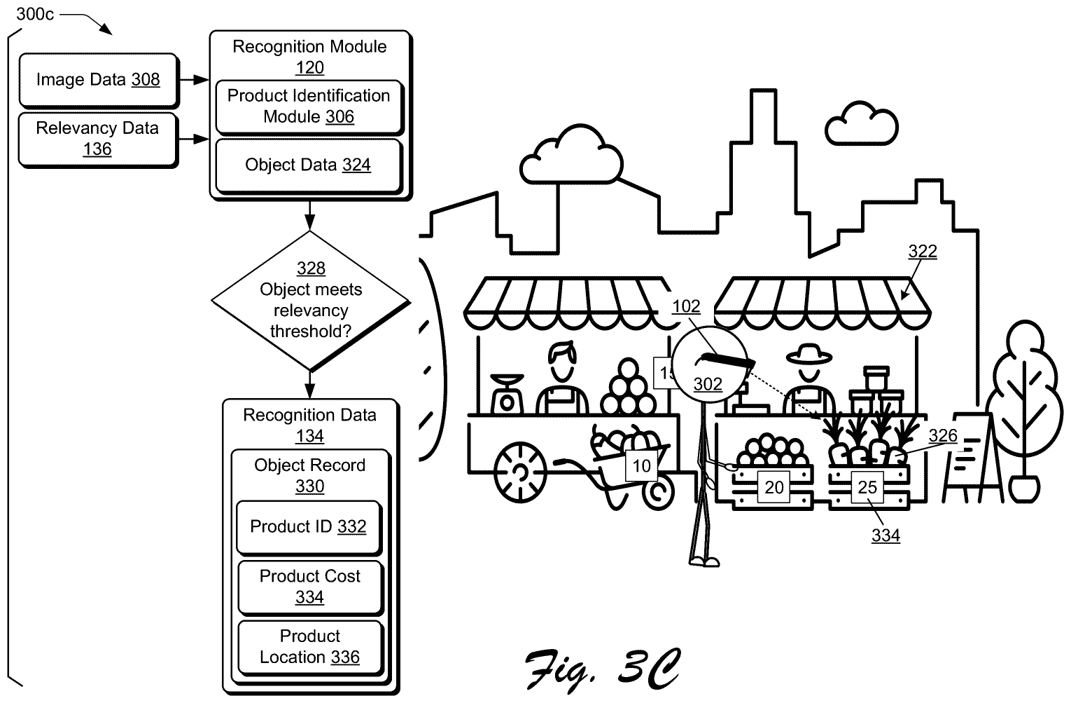

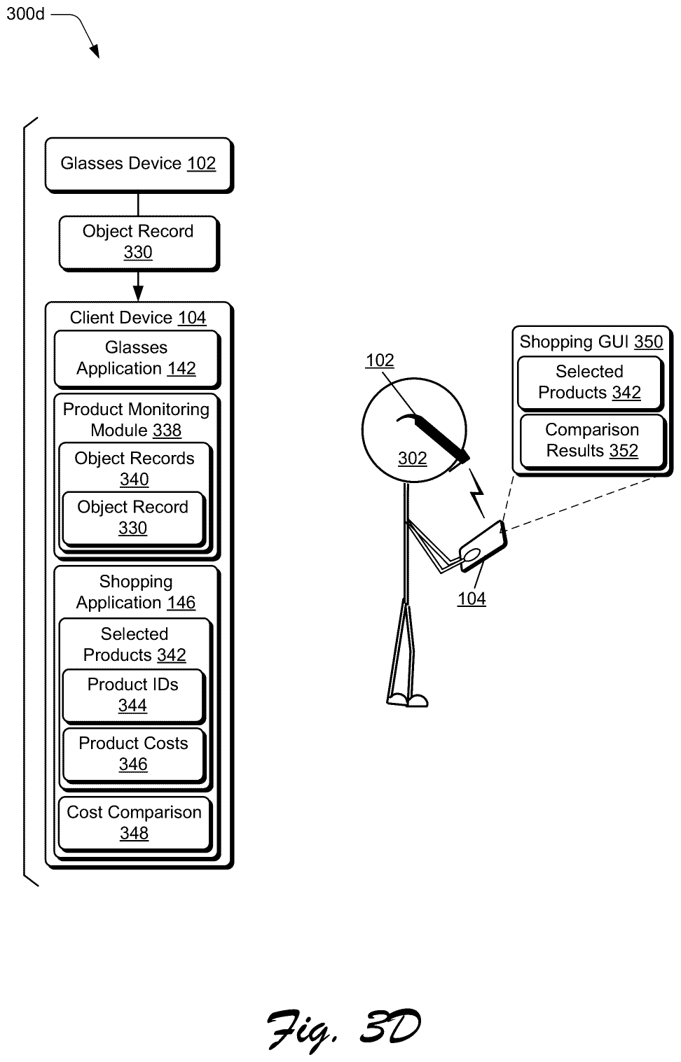

FIGS. 3A-3C depict different aspects of scenarios 300 for tracking costs of objects of interest in accordance with one or more implementations. The scenarios 300 can be implemented in the environment 100 and incorporates attributes of the environment 100 introduced above.

In FIG. 3A illustrates a scenario 300a in which a user 302 is wearing the glasses device 102 and the location module 118 receives sensor data 132 from the sensors 116. The sensor data 132, for instance, includes position data 304 generated by the position sensors 126. Further, the position data 304 indicates a position of the glasses device 102 and thus the user 302. The position data 304, for instance, indicates a geographic position of the glasses device 102 and/or other indication of a location of the glasses device 102. The recognition module 120 receives the position data 304 and determines that based at least in part on the location of the glasses device 102, product identification is to be performed. For instance, at some locations (e.g., a user's home, a user's office, etc.), product identification functionality is disabled. At other locations, however, (e.g., outside of home and/of office) product identification functionality is enabled, e.g., active.

Accordingly, the recognition module 120 initiates a product identification module 306 and receives image data 308 such as from the cameras 124. The recognition module 120 can utilize the image data 308 to attempt to perform object recognition on objects detected in the image data 308 and to generate object data 310. The object data 310, for instance, can include attributes of objects detected in the image data 308, such as objects IDs for objects that are recognized in the image data 308. Further, the object data 310 can include position and time information for objects detected in the image data 308, such as a location at which particular objects are detected, a date, day, and time when the objects are detected, and so forth.

The product identification module 306 can utilize the object data 310 and the relevancy data 136 to determine how data pertaining to objects identified in the object data 310 is to be processed. The product identification module 306, for instance, can compare the object data 310 to the relevancy data 136 to determine whether objects identified in the object data 310 are to be stored for subsequent processing or are to be ignored, e.g., not stored.

FIG. 3B illustrates a scenario 300b for tracking costs of objects of interest in accordance with one or more implementations. The scenario 300b, for instance, represents a continuation of the scenario 300a. In the scenario 300b the user 302 changes position to a location 312. Further, object data 314 is generated for an object 316 captured in the image data 308. The recognition module 120, for instance, performs object recognition on the image data 308 to recognize an identity of the object 316, and thus the object data 314 identifies the object 316. Alternatively the recognition module 120 is not able to recognize the object 316 and the object data 314 indicates that the object 316 represents an unrecognized object detected in the image data 308.

The product identification module 306 can process the object data 314 using the relevancy data 136 to determine whether to retain the object data 314 or discard the object data 314. The relevancy data 136, for instance, identifies objects of interest to the user 302, such as products that are indicated as and/or predicted to be of interest to the user 302. Different examples of the relevancy data 136 are discussed above. Accordingly, based on the object data 314 and the relevancy data 136, the product identification module 306 determines at 318 whether the object 316 meets a relevancy threshold such as defined by the relevancy data 136. The relevancy threshold, for instance, can specifically identify products of interest to the user 302, such as using product identifiers. Alternatively or additionally, the relevancy threshold can represent a defined relevancy value.

For instance, where the relevancy threshold includes identities of products of interest, the product identification module 306 can compare an identity of the object 316 with identities of the products of interest to determine if the object 316 matches a product of interest, e.g., meets the relevancy threshold. In another example where the relevancy threshold includes a relevancy threshold value, a relevancy score can be generated for the object 316 and the relevancy score compared to the relevancy threshold value to determine if the relevancy score meets (e.g., is equal to or greater than) the relevancy threshold value.

In the scenario 300b the object 316 does not meet the relevancy score threshold and thus at 320 the object data 314 is ignored. The object data 314 representing the object 316, for instance, is not stored and/or is discarded.

FIG. 3C illustrates a scenario 300c for tracking costs of objects of interest in accordance with one or more implementations. The scenario 300c, for instance, represents a continuation of the scenarios 300a, 300b. In the scenario 300c the user 302 changes position to a location 322. Further, object data 324 is generated for an object 326 captured in the image data 308. The recognition module 120, for instance, performs object recognition on the image data 308 to recognize an identity of the object 326, and thus the object data 324 identifies the object 326.

In a similar way to the scenario 300b discussed above, the product identification module 306 can process the object data 324 using the relevancy data 136 to determine whether to retain or discard the object data 324. The product identification module 306, for instance, determines at 328 whether the object 326 meets a relevancy threshold such as defined by the relevancy data 136. In the scenario 300c the object 326 meets and/or exceeds the relevancy threshold and thus an object record 330 is generated and stored for the object 326.

The object record 330 includes various information about the object 326 including a product ID 332, a product cost 334, and a product location 336. The product ID 332, for instance, identifies the object 326 such as using various types of identifiers. For example, the product ID 332 includes a name for the object 326, e.g., a product name such as “carrot” in this particular example. Thus, the product ID 332 can represent a plain language (e.g. human readable) identifier. Alternatively or additionally the product ID 332 can include a machine readable identifier for the object 326, such as a universal product code (UPC), a stock keeping unit (SKU), a vendor-specific product code, and so forth.

The product cost 334 represents a price to purchase the object 326, such as indicated in any suitable currency type. In implementations the product identification module 306 can recognize the product cost 334 such as based on physical proximity to the object 326. Alternatively or additionally the product cost 334 may be labeled at the location 322 with an ID for the object 326, thus enabling correlation of the product cost 334 with the object 326. The product location 336 includes data that describes a location where the object 326 is detected, such as based on position data 304 generated by the location module 118 that identifies the location 322.

Alternatively or additionally the product location 336 can be determined in other ways such as by visual recognition of a name of the location 322, e.g., based on a sign and/or other placename identifier. As another implementation the location 322 may implement a wireless tag that emits data identifying the location 322, and the product location 336 can be detected by a wireless sensor 128. For instance, a UWB tag may be present at the location 322 that emits location data identifying the location 322, and the UWB sensor 130 can detect the location data and provide the location data to the product identification module 306 for use as part of the product location.

Accordingly, the object record 330 can be stored and utilized for various purposes, such as for cost comparison with other instances of the object 326 and/or similar objects.

FIG. 3D illustrates a scenario 300d for comparing costs of products in accordance with one or more implementations. The scenario 300d, for instance, represents a continuation of the scenarios 300a-300c. In the scenario 300d the glasses device 102 connects to the client device 104 and transfers the object record 330 to the client device 104, such as via wired and/or wireless connectivity. In at least one implementation the glasses application 142 serves as broker functionality between the glasses device 102 and the client device 104, such as to enable data transfer between the devices, e.g., transfer of the object record 330 to the client device 104.

According to implementations a product monitoring module 338 on the client device 104 can manage the object record 330. For instance, the product monitoring module 338 manages multiple object records 340 including the object record 330. The object records 340, for instance, each include similar data types as the object record 330, such as different products IDs, product costs, product locations, etc. Further, the object records 340 can be generated in similar ways as the object record 330, such as via visual observation of objects detected at different physical locations.

Further to the scenario 300d the product monitoring module 338 can provide data from the object records 340 to functionalities of the client device 104. For instance, the shopping application 146 includes selected products 342 that represent products of interest for purchase, such as by the user 302. Further, the selected products 342 include respective products IDs 344 that identify each selected product 342 and product costs 346 that identify a price for each selected product 342. The user 302, for example, interacts with the shopping application 146 to select different selected products 342. Alternatively or additionally the selected products 342 are automatically identified from a list, such as a shopping list created by the user 302, a list generated based on past purchase history of the user 302, etc.

The shopping application 146 can access the object records 340 (e.g., via interaction with the product monitoring module 338) and perform cost comparison 348 by comparing attributes of products identified in the selected products 342 and attributes of products identified in the object records 340. As part of the cost comparison 348, for instance, the shopping application 146 can determine cost differences between similar products identified in the selected products 342 and the object records 340. For example, as part of the cost comparison 348 based on the object record 330, the shopping application 146 can determine whether the product cost 334 for the product ID 332 is cheaper, substantially the same, or more expensive than an equivalent product identified in the selected products 342, such as by matching the product ID 332 to a corresponding product ID 344, and the product cost 334 to a respective product cost 346 associated with the corresponding product ID 344.

Further to the scenario 300d the shopping application 146 outputs a shopping GUI 350 that is displayed on the client device 104 and that is populated with at least some of the selected products 342 and comparison results 352 from the cost comparison 348. The comparison results 352, for instance, can identify cost differences between the selected products 342 and equivalent products from the object records 340.

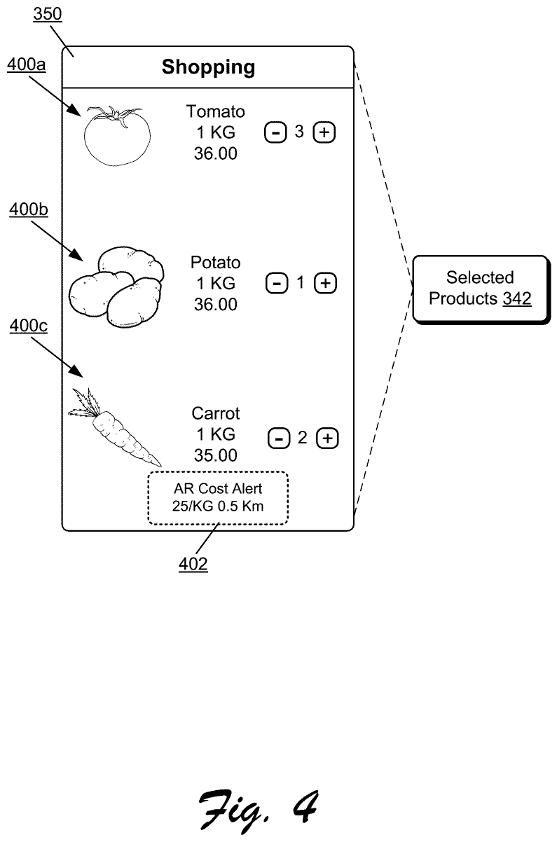

FIG. 4 illustrates an example of the shopping GUI 350 in accordance with one or more implementations. The shopping GUI 350 is populated with various information and functionality for enabling interaction with the shopping application 146. In this particular example the shopping GUI 350 displays product indicia 400a, 400b, 400c, which represent visual representations of different instances of the selected products 342. Each of the product indicia 400 indicate a respective product ID and respective product cost.

In this particular example the shopping application 146 presents a cost alert 402 adjacent the product indicia 400c. The cost alert 402, for instance, is presented based at least in part on the cost comparison 348, such as based on the object record 330. The cost alert 402 indicates that a lower cost for a product represented by the product indicia 400c is available. Further, the cost alert 402 identifies the lower cost and a distance at which the lower cost is available, e.g., relative to the client device 104 and/or the glasses device 102. Further to this particular example the cost alert 402 indicates that the cost alert 402 is based at least in part on data captured via the glasses device 102, e.g., “AR Cost Alert.” In implementations, the cost alert 402 is selectable to obtain additional information about the cost alert 402. For instance, consider the following example.

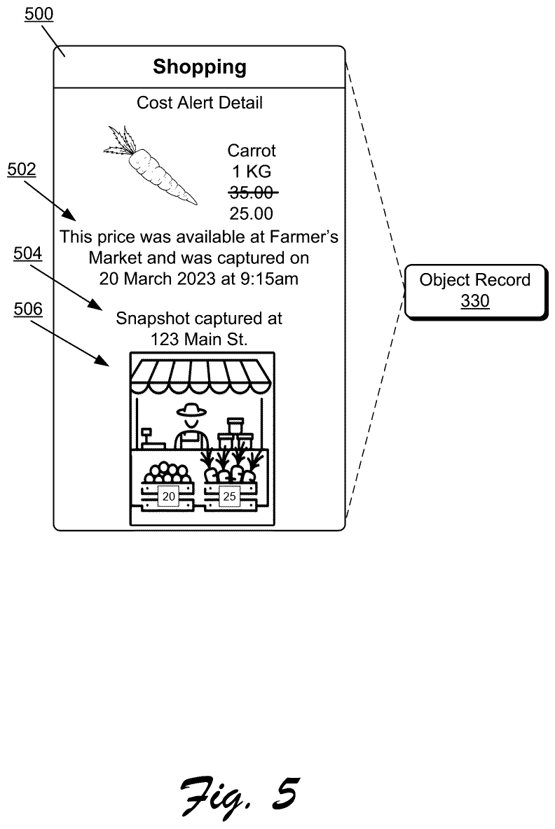

FIG. 5 illustrates an example alert detail GUI 500 in accordance with one or more implementations. In at least one implementation the alert detail GUI 500 is presented in response to user selection of the cost alert 402, introduced above. The alert detail GUI 500, for instance, includes further information pertaining to the cost alert 402, including historical information 502, location information 504, and visual information 506. In implementations at least some of the information presented in the alert detail GUI 500 is obtained from the object record 330.

The historical information 502 includes information about how information that generated the cost alert 402 was obtained, e.g., the object record 330. The historical information 502, for instance, identifies a location (e.g., a placename) where the cost was observed and a time and date on which the cost was observed, e.g., by the glasses device 102. The location information 504 indicates more specific location information behind the cost alert 402, e.g., a street address, geographical coordinates, etc. The visual information 506 includes an image that was captured and used to generate the cost alert 402, e.g., to generate the object record 330. The visual information 506, for instance, includes a digital image from which information used to generate the object record 330 was extracted, such as the product ID 332 and/or the product cost 334.

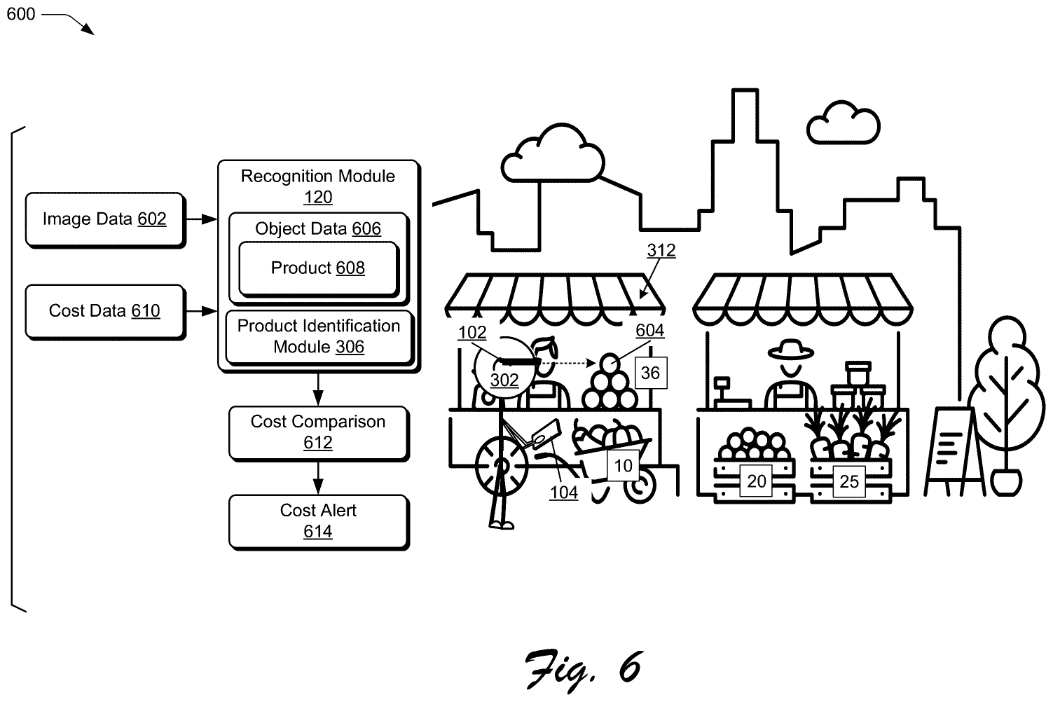

FIG. 6 illustrates a scenario 600 for performing cost comparison in a physical shopping environment in accordance with one or more implementations. The scenario 600, for instance, represents an alternative or additional implementation to the scenarios described above.

In the scenario 600 the user 302 visits the location 312 to shop for products while wearing the glasses device 102 and carrying the client device 104, e.g., a smartphone. Accordingly, the actions and operations described in the scenario 600 may be performed by the glasses device 102, the client device 104, and/or via interaction between the glasses device 102 and the client device 104. Further, the glasses device 102 and/or the client device 104 may connect to the network service 108 to obtain and/or transfer data and to leverage functionality provided by the network service 108.

Further to the scenario 600 the recognition module 120 receives image data 602 and performs object recognition using the image data 602. In this particular example the recognition module 120 recognizes an object 604 and generates object data 606 that describes attributes of the object 604. The object 604, for instance, represents a recognized product 608 and thus the object data 606 includes a product ID and a cost of the product 608. A visual representation of the cost (“36”), for instance, is positioned adjacent the object 604 and is recognized by the recognition module 120.

Accordingly, the product identification module 306 accesses cost data 610 and performs a cost comparison 612 to compare the cost of the product 608 to similar (e.g., equivalent) products available at other locations, such as other physical locations, online locations (e.g., the shopping application 146), etc. The cost data 610 can be obtained from various sources, such as data storage of the glasses device 102, the client device 104, the network service 108, and so forth.

Based on the cost comparison 612 a cost alert 614 is output, such as via the glasses device 102 and/or the client device 104. The cost alert 614, for instance, includes information resulting from the cost comparison 612. For example, the cost alert 614 can include an indication of the cost of the product 608 relative to similar products available elsewhere. Accordingly, real-time cost comparison can be performed and without direct user interaction to identify products and retrieve cost data from the products.

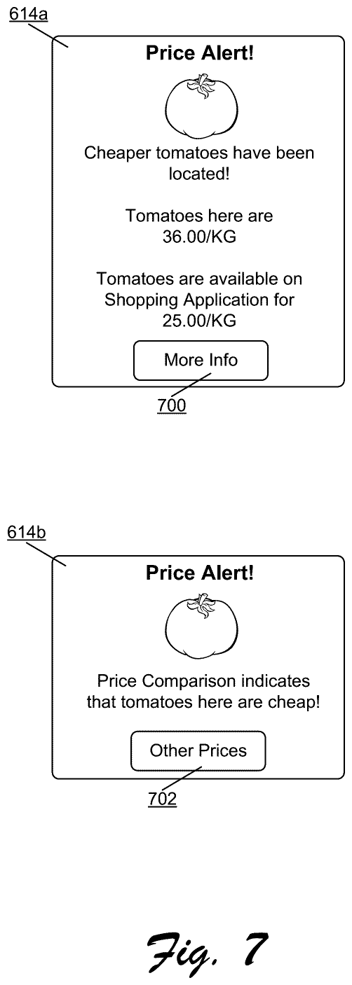

FIG. 7 illustrates different examples of the cost alert 614 in accordance with one or more implementations. For instance, a cost alert 614a includes an indication that a cheaper cost for the product 608 (e.g., tomatoes) is available elsewhere other than the location 312, e.g., the shopping application 146. The cost alert 614a also includes a selectable control 700 that is selectable to access information about the cheaper product. For instance, the selectable control 700 is selectable to access the shopping application 146 such as for performing online shopping for the product 608. Alternatively or additionally where the cheaper cost is available at a different physical shopping location, the selectable control 700 is selectable to present additional information such as an address of and/or directions to the other physical shopping location.

A cost alert 614b includes an indication that the cost of the product 608 is cheap at the location 312, e.g., that no cheaper prices for the product 608 are identified as part of the cost comparison 612. The cost alert 614b also includes a selectable control 702 that is selectable to present information about prices of the product 608 at other sources, such as the shopping application 146 and/or other physical shopping locations.

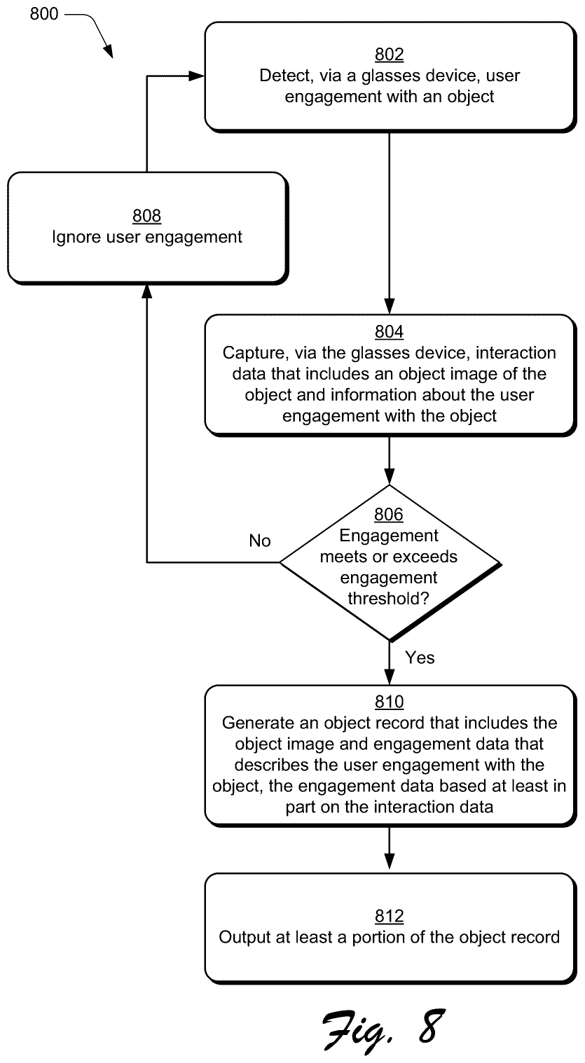

FIG. 8 illustrates a flow chart depicting an example method 800 for tracking user engagement with an object in accordance with one or more implementations. At 802 it is detected, via a glasses device, user engagement with an object. The recognition module 120 (e.g., using the interaction detection module 212) detects that a user engages with an object of interest 204.

At 804 interaction data that includes an object image of the object and information about the user engagement with the object is captured via the glasses device. The glasses device 102, for instance, captures an image (e.g., a still image and/or video data) of the object, such as concurrently with the user engagement with the object. Further, captured interaction data about the user engagement with the object can include an object identifier that identifies the object, such as based on image recognition performed on an image of the object.

At 806 it is determined whether the user engagement meets or exceeds an engagement threshold. The interaction detection module 212, for instance, compares attributes of the user engagement with the engagement threshold. In at least one implementation the engagement threshold represents a minimum duration of time, and thus a duration of time over which the user engagement with the object of interest occurs can be compared to the threshold duration of time.

If the user engagement does not meet or exceed the engagement threshold (“No”), at 808 the user engagement is ignored. For instance, data generated pertaining to the detected user engagement is not stored and/or an object record for the detected user engagement is not generated. If the user engagement meets or exceeds the engagement threshold (“Yes”), at 810 an object record is generated that includes the object image and engagement data that describes the user engagement with the object, the engagement data based at least in part on the interaction data. The engagement data, for instance, includes a duration of the user engagement, whether the user engagement is passive (e.g., the user views the object of interest) or active (e.g., the user physically interacts with the object of interest), a date, day, and time of the user interaction, etc. At 812 at least a portion of the object record is output. A user, for instance, can access the object record to obtain information and content from the object record, such image data depicting the object, information describing the object, engagement data describing the user engagement with the object, etc.

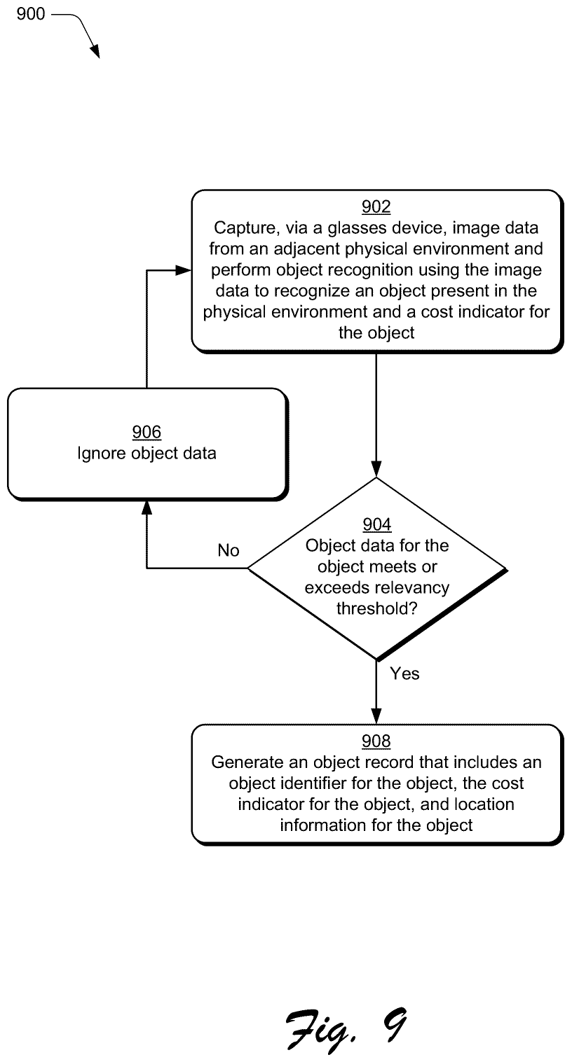

FIG. 9 illustrates a flow chart depicting an example method 900 for tracking cost indicators for objects in accordance with one or more implementations. At 902 image data is captured, via a glasses device, from an adjacent physical environment and object recognition is performed using the image data to recognize an object present in the physical environment and a cost indicator for the object. The recognition module 120, for instance, obtains image data (e.g., sensor data) of an adjacent physical environment captured via a camera 124 of the glasses device 102. The recognition module 120 can then perform object recognition on the image data to recognize different objects present in the physical environment. The recognition module 120, for instance, recognizes a particular object and a cost indicator (e.g., price) associated with the particular object.

At 904 object data for the object is compared to a relevancy threshold to determine if the object data meets or exceeds the relevancy threshold. The product identification module 306, for instance, compares the object data to the relevancy threshold. Different examples of object data and a relevancy threshold are described above. If the object data does not meet or exceed the relevancy threshold (“No”), at 906 the object data is ignored. For instance, the object data is not stored and/or an object record for the object is not generated.

If the object data meets or exceeds the relevancy threshold (“Yes”), at 908 an object record is generated that includes an object identifier for the object, the cost indicator for the object, and location information for the object. The product identification module 306, for instance, determines that the object data meets or exceeds the relevancy threshold and thus generates an object record for the object. As described above, the object record can be used for various purposes, such as for cost comparison with other similar and/or equivalent objects available from other sources.

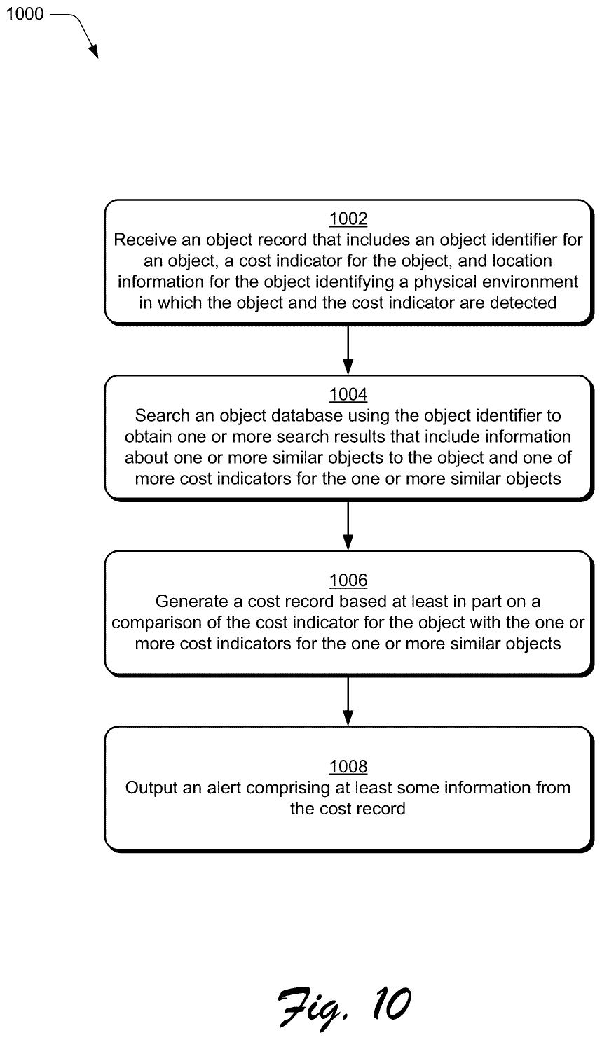

FIG. 10 illustrates a flow chart depicting an example method 1000 for generating cost records for objects in accordance with one or more implementations. At 1002 an object record is received that includes an object identifier for an object, a cost indicator for the object, and location information for the object identifying a physical environment in which the object and the cost indicator are detected. The client device 104, for instance, obtains the object record from the glasses device 102. In at least one implementation the glasses device 102 automatically transfers (e.g., transmits) the object record to the client device 104, such as based on detecting the client device 104 within a threshold physical proximity to the glasses device 102.

At 1004 an object database is searched using the object identifier to obtain one or more search results that include information about one or more similar objects to the object and one of more cost indicators for the one or more similar objects. The object database, for instance, can be maintained by the client device 104 and/or the network service 108. Thus, the client device 104 and/or the network service 108 can search the object database to locate objects that are similar to the object identified by the object identifier.

At 1006 a cost record is generated based at least in part on a comparison of the cost indicator for the object with the one or more cost indicators for the one or more similar objects. The cost record, for instance, identifies the object as well as the similar objects identified via the search, as well as cost indicators for the respective objects. Further, the cost record can indicate cost differentials between the different objects, e.g., which objects have higher cost values and/or lower cost values than other objects.

At 1008 an alert is output comprising at least some information from the cost record. The alert, for instance, can indicate relative cost values of the different objects, such as whether one object has a lower cost value (e.g., is cheaper) than another object. Different example alerts are described above and in the accompanying figures.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

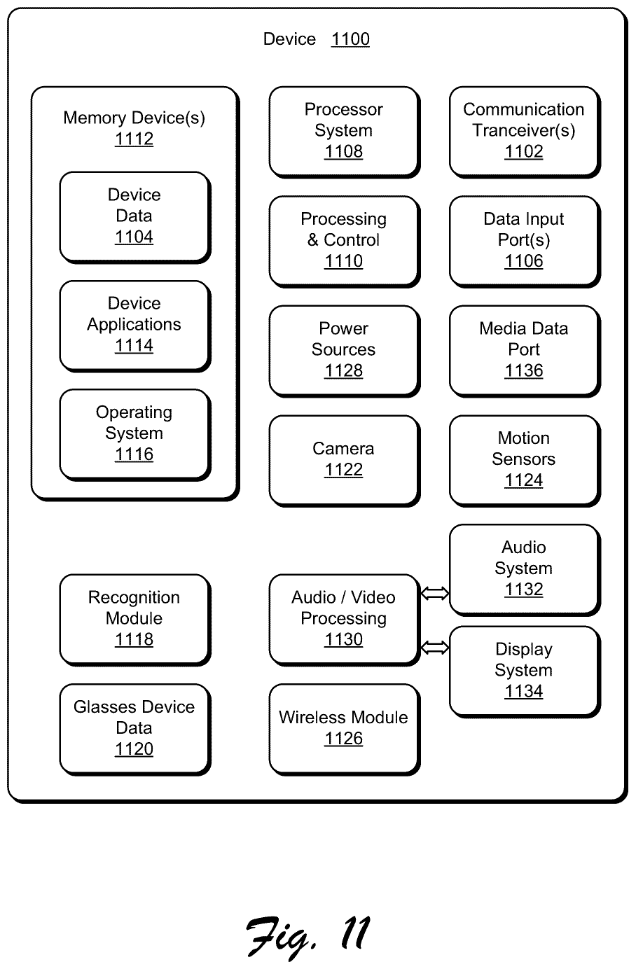

FIG. 11 illustrates various components of an example device 1100 in which aspects of user state for user image in media content can be implemented. The example device 1100 can be implemented as any of the devices described with reference to the previous FIGS. 1-10, such as any type of mobile device, mobile phone, mobile device, wearable device, tablet, computing, communication, entertainment, gaming, media playback, and/or other type of electronic device. For example, the glasses device 102 and/or the client device 104 as shown and described with reference to FIGS. 1-10 may be implemented as the example device 1100.

The device 1100 includes communication transceivers 1102 that enable wired and/or wireless communication of device data 1104 with other devices. The device data 1104 can include any of device identifying data, device location data, wireless connectivity data, and wireless protocol data. Additionally, the device data 1104 can include any type of audio, video, and/or image data. Example communication transceivers 1102 include wireless personal area network (WPAN) radios compliant with various IEEE 1102.15 (Bluetooth™) standards, wireless local area network (WLAN) radios compliant with any of the various IEEE 1102.11 (Wi-Fi™) standards, wireless wide area network (WWAN) radios for cellular phone communication, wireless metropolitan area network (WMAN) radios compliant with various IEEE 1102.16 (WiMAX™) standards, and wired local area network (LAN) Ethernet transceivers for network data communication.

The device 1100 may also include one or more data input ports 1106 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 1100 includes a processing system 1108 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 1110. The device 1100 may further include any type of a system bus or other data and command transfer system that couples the various components within the device. A system bus can include any one or combination of different bus structures and architectures, as well as control and data lines.

The device 1100 also includes computer-readable storage memory 1112 (e.g., memory devices) that enable data storage, such as data storage devices that can be accessed by a computing device, and that provide persistent storage of data and executable instructions (e.g., software applications, programs, functions, and the like). Examples of the computer-readable storage memory 1112 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 1100 may also include a mass storage media device.

The computer-readable storage memory 1112 provides data storage mechanisms to store the device data 1104, other types of information and/or data, and various device applications 1114 (e.g., software applications). For example, an operating system 1116 can be maintained as software instructions with a memory device and executed by the processing system 1108. The device applications may also include a device manager, such as any form of a control application, software application, signal-processing and control module, code that is native to a particular device, a hardware abstraction layer for a particular device, and so on. Computer-readable storage memory 1112 represents media and/or devices that enable persistent and/or non-transitory storage of information in contrast to mere signal transmission, carrier waves, or signals per se. Computer-readable storage memory 1112 do not include signals per se or transitory signals.

In this example, the device 1100 includes a capture module 1118 that implements aspects of user state for user image in media content and may be implemented with hardware components and/or in software as one of the device applications 1114. In an example, the recognition module 1118 can be implemented as the recognition module 120 described in detail above. In implementations, the recognition module 1118 may include independent processing, memory, and logic components as a computing and/or electronic device integrated with the device 1100. The device 1100 also includes glasses device data 1120 for implementing aspects of user state for user image in media content and may include data from and/or utilized by the recognition module 1118.

In this example, the example device 1100 also includes a camera 1122 and motion sensors 1124, such as may be implemented in an inertial measurement unit (IMU). The motion sensors 1124 can be implemented with various sensors, such as a gyroscope, an accelerometer, and/or other types of motion sensors to sense motion of the device. The various motion sensors 1124 may also be implemented as components of an inertial measurement unit in the device.

The device 1100 also includes a wireless module 1126, which is representative of functionality to perform various wireless communication tasks. For instance, for the client device 102, the wireless module 1126 can be leveraged to scan for and detect wireless networks, as well as negotiate wireless connectivity to wireless networks for the client device 102. The device 1100 can also include one or more power sources 1128, such as when the device is implemented as a mobile device. The power sources 1128 may include a charging and/or power system, and can be implemented as a flexible strip battery, a rechargeable battery, a charged super-capacitor, and/or any other type of active or passive power source.

The device 1100 also includes an audio and/or video processing system 1130 that generates audio data for an audio system 1132 and/or generates display data for a display system 1134. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 1136. In implementations, the audio system and/or the display system are integrated components of the example device. Alternatively, the audio system and/or the display system are external, peripheral components to the example device.

Although implementations of user state for user image in media content have been described in language specific to features and/or methods, the subject of the appended claims is not necessarily limited to the specific features or methods described. Rather, the features and methods are disclosed as example implementations of user state for user image in media content, and other equivalent features and methods are intended to be within the scope of the appended claims. Further, various different examples are described, and it is to be appreciated that each described example can be implemented independently or in connection with one or more other described examples.

In addition to the previously described methods, any one or more of the following:

In some aspects, the techniques described herein relate to a system including: one or more processors; and computer-readable storage media storing instructions that are executable by the one or more processors to: capture, via a glasses device, image data from an adjacent physical environment and perform object recognition using the image data to recognize an object present in the physical environment and a cost indicator for the object: compare object data for the object to a relevancy threshold; and generate, in an event that the object data at least meets the relevancy threshold, an object record that includes an object identifier for the object, the cost indicator for the object, and location information for the object.

In some aspects, the techniques described herein relate to a system, wherein the instructions are executable by the one or more processors to detect that the glasses device moves from a first location to a second location associated with the physical environment, and to initiate performing the object recognition based at least in part on the move to the second location.

In some aspects, the techniques described herein relate to a system, wherein the instructions are executable by the one or more processors to recognize the cost indicator as an image of a numerical value positioned adjacent the object in the physical environment.

In some aspects, the techniques described herein relate to a system, wherein the relevancy threshold includes an indication of objects of interest to a user associated with the glasses device.

In some aspects, the techniques described herein relate to a system, wherein the instructions are executable by the one or more processors to capture, in the event that the object data at least meets the relevancy threshold, an image of the physical environment and store the image as part of the object record.

In some aspects, the techniques described herein relate to a system, wherein the instructions are executable by the one or more processors to: capture, via the glasses device, different image data from the adjacent physical environment and perform object recognition using the different image data to recognize a different object present in the physical environment and a cost indicator for the different object; compare different object data for the different object to the relevancy threshold; and ignore the different object data based on the different object data not meeting the relevancy threshold.

In some aspects, the techniques described herein relate to a system, wherein the instructions are executable by the one or more processors to: obtain information pertaining to the object from a wireless tag detected in the physical environment; and include at least some of the information in the object record, the information including one or more of the identifier for the object, the cost indicator for the object, or the location information for the object.

In some aspects, the techniques described herein relate to a system, wherein the instructions are executable by the one or more processors to: receive an indication of a cost difference between the object present in the physical environment and a similar object available from a different source; and output, via the glasses device, an alert indicating the cost difference.

In some aspects, the techniques described herein relate to a system, wherein the instructions are executable by the one or more processors to: detect that the glasses device is in proximity to a client device; and automatically communicate the object record to the client device.

In some aspects, the techniques described herein relate to a method including: receiving an object record that includes an object identifier for an object, a cost indicator for the object, and location information for the object identifying a physical environment in which the object and the cost indicator are detected: searching an object database using the object identifier to obtain one or more search results that include information about one or more similar objects to the object and one of more cost indicators for the one or more similar objects; and generating a cost record based at least in part on a comparison of the cost indicator for the object with the one or more cost indicators for the one or more similar objects.

In some aspects, the techniques described herein relate to a method, wherein receiving the object record includes receiving the object record from a glasses device.

In some aspects, the techniques described herein relate to a method, wherein the cost record indicates at least one of that the cost indicator for the object has a lesser value than the one or more cost indicators for the one or more similar objects, or that the cost indicator for the object has a greater value than the one or more cost indicators for the one or more similar objects.

In some aspects, the techniques described herein relate to a method, further including outputting an alert including at least some information from the cost record.

In some aspects, the techniques described herein relate to a method, further including outputting the alert in response to determining that a current location corresponds to the physical environment in which the object is detected.

In some aspects, the techniques described herein relate to a method, wherein the alert includes an indication that the cost indicator for the object has a lesser value than the one or more cost indicators for the one or more similar objects.

In some aspects, the techniques described herein relate to a method, wherein the alert includes a selectable control that is selectable to present additional information about the physical environment in which the object is detected, including a snapshot of the physical environment captured when the object was detected.

In some aspects, the techniques described herein relate to a system including: one or more processors; and computer-readable storage media storing instructions that are executable by the one or more processors to: detect, via a glasses device, user engagement with an object and capture interaction data that includes an object image of the object and information about the user engagement with the object; and generate, based on the user engagement meeting or exceeding an engagement threshold, an object record that includes the object image and engagement data that describes the user engagement with the object, the engagement data based at least in part on the interaction data.

In some aspects, the techniques described herein relate to a system, wherein the engagement threshold includes a threshold duration of time over which the user engagement with the object occurs.

In some aspects, the techniques described herein relate to a system, further including performing object recognition of the object and including an object identifier for the object in the object record.

In some aspects, the techniques described herein relate to a system, wherein the engagement data includes an indication of whether the user engagement includes passive engagement or active engagement.

1. A system comprising:
one or more processors; and
computer-readable storage media storing instructions that are executable by the one or more processors to:
capture, via a glasses device, image data from an adjacent physical environment and perform object recognition using the image data to recognize an object present in the physical environment and a cost indicator for the object;
compare object data for the object to a relevancy threshold; and
generate, in an event that the object data at least meets the relevancy threshold, an object record that includes an object identifier for the object, the cost indicator for the object, and location information for the object.

2. The system of claim 1, wherein the instructions are executable by the one or more processors to detect that the glasses device moves from a first location to a second location associated with the physical environment, and to initiate performing the object recognition based at least in part on the move to the second location.

3. The system of claim 1, wherein the instructions are executable by the one or more processors to recognize the cost indicator as an image of a numerical value positioned adjacent the object in the physical environment.

4. The system of claim 1, wherein the relevancy threshold comprises an indication of objects of interest to a user associated with the glasses device.

5. The system of claim 1, wherein the instructions are executable by the one or more processors to capture, in the event that the object data at least meets the relevancy threshold, an image of the physical environment and store the image as part of the object record.

6. The system of claim 1, wherein the instructions are executable by the one or more processors to:
capture, via the glasses device, different image data from the adjacent physical environment and perform object recognition using the different image data to recognize a different object present in the physical environment and a cost indicator for the different object;
compare different object data for the different object to the relevancy threshold; and
ignore the different object data based on the different object data not meeting the relevancy threshold.

7. The system of claim 1, wherein the instructions are executable by the one or more processors to:
obtain information pertaining to the object from a wireless tag detected in the physical environment; and
include at least some of the information in the object record, the information comprising one or more of the identifier for the object, the cost indicator for the object, or the location information for the object.

8. The system of claim 1, wherein the instructions are executable by the one or more processors to:
receive an indication of a cost difference between the object present in the physical environment and a similar object available from a different source; and
output, via the glasses device, an alert indicating the cost difference.

9. The system of claim 1, wherein the instructions are executable by the one or more processors to:
detect that the glasses device is in proximity to a client device; and
automatically communicate the object record to the client device.

10. A method comprising:
receiving an object record that includes an object identifier for an object, a cost indicator for the object, and location information for the object identifying a physical environment in which the object and the cost indicator are detected;
searching an object database using the object identifier to obtain one or more search results that include information about one or more similar objects to the object and one of more cost indicators for the one or more similar objects; and
generating a cost record based at least in part on a comparison of the cost indicator for the object with the one or more cost indicators for the one or more similar objects.

11. The method of claim 10, wherein receiving the object record comprises receiving the object record from a glasses device.

12. The method of claim 10, wherein the cost record indicates at least one of that the cost indicator for the object has a lesser value than the one or more cost indicators for the one or more similar objects, or that the cost indicator for the object has a greater value than the one or more cost indicators for the one or more similar objects.

13. The method of claim 10, further comprising outputting an alert comprising at least some information from the cost record.

14. The method of claim 13, further comprising outputting the alert in response to determining that a current location corresponds to the physical environment in which the object is detected.

15. The method of claim 13, wherein the alert comprises an indication that the cost indicator for the object has a lesser value than the one or more cost indicators for the one or more similar objects.

16. The method of claim 15, wherein the alert comprises a selectable control that is selectable to present additional information about the physical environment in which the object is detected, including a snapshot of the physical environment captured when the object was detected.

17. A system comprising:
one or more processors; and
computer-readable storage media storing instructions that are executable by the one or more processors to:
detect, via a glasses device, user engagement with an object and capture interaction data that includes an object image of the object and information about the user engagement with the object; and
generate, based on the user engagement meeting or exceeding an engagement threshold, an object record that includes the object image and engagement data that describes the user engagement with the object, the engagement data based at least in part on the interaction data.

18. The system of claim 17, wherein the engagement threshold comprises a threshold duration of time over which the user engagement with the object occurs.

19. The system of claim 17, further comprising performing object recognition of the object and including an object identifier for the object in the object record.

20. The system of claim 17, wherein the engagement data comprises an indication of whether the user engagement comprises passive engagement or active engagement.
